(19) United States
(12) Patent Application Publication
(10) Pub. No.: US 2012/0037436 A1
(43) Pub. Date: Feb. 16, 2012

(54) MOTOR UNIT AND VEHICLE EQUIPPED THEREWITH

(75) Inventor: Tack Hwan Kwon, Gunpo (KR)

(73) Assignees: Kia Motors Corporation, Seoul (KR); Hyundai Motor Company, Seoul (KR)

(21) Appl. No.: 12/953,954

(22) Filed: Nov. 24, 2010

(30) Foreign Application Priority Data
Aug. 13, 2010 (KR) 10-20100078518

(51) Int. Cl. B60L 11/00; H01R 4/02; B60K 1/00; H02K 11/00

(52) U.S. Cl. 180/65.1; 310/71

(57) ABSTRACT

A motor unit according to an exemplary embodiment of the present invention may include a bus bar receiving a current from a power supply, a wire that is wound along the bus bar, and a connecting portion that is extended from the bus bar to be electrically connected to one end portion of the wire, wherein the connecting portion has a circular bent portion that is formed along the outer circumference of the wire.

Accordingly, the connecting portion of the bus bar includes a bent portion, and one end portion of the wire wound on the bus bar contacts the bent portion such that welding becomes easier and the welded portion is firm. Further, the connecting portion includes the first extension portion and the second extension portion that are at an acute angle such that the wire is not separated from the connecting portion and the welding process becomes easier.

### CROSS-REFERENCE TO RELATED APPLICATION

This application claims priority to and the benefit of Korean Patent Application No. 10-2010-0078518 filed in the Korean Intellectual Property Office on Aug. 13, 2010, the entire contents of which are incorporated herein by reference.

### BACKGROUND OF THE INVENTION

(a) Field of the Invention

The present invention relates to a motor unit. More particularly, the present invention relates to a motor unit that uses electrical energy to generate torque for moving a vehicle, and a vehicle having it.

(b) Description of the Related Art

Recently, automobiles with good fuel economy have been in high demand, and as one example of automobile manufactures' efforts to meet these demands, hybrid cars with extremely low fuel consumption have been developed.

Particularly, a hybrid car is provided with an auxiliary power mechanism (a motor assist mechanism), wherein an engine provides the main power and a DC brushless motor assists the engine upon acceleration or the like.

The motor assist mechanism is subject to many constraints in installation, since a brushless motor is disposed in a limited space between the engine and a transmission in an engine compartment. Thus, such a brushless motor is required to have a thin configuration.

As described above, the compact brushless motor includes a rotor directly connected to a crank shaft of an engine, and a ring-like stator enclosing the rotor. The stator includes magnetic poles that have windings on cores, a stator holder that contains the magnetic poles, and a centralized distribution unit that concentratedly distributes current to the windings.

The central distribution unit is used in a 3-phase DC brushless motor to have ring-like bus bars, and each bus bar includes a ring-like body, a terminal portion protruding in a radial direction of the body, and a connecting portion protruding in an opposite direction of the terminal portion. The terminal portion receives a current from a battery, and the connecting portion is electrically connected to an end portion of the wire that is wound on the bus bar.

It is necessary to securely connect one end of the wire wound on the bus bar to the connecting portion of the bus bar in a compact space.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a motor unit having advantages of securely connecting a connecting portion of a bus bar with a wire.

A motor unit according to an exemplary embodiment of the present invention may include a bus bar receiving a current from a power supply, a wire that is wound along the bus bar, and a connecting portion that is extended from the bus bar to be electrically connected to one end portion of the wire, wherein the connecting portion has a circular bent portion that is formed along the outer circumference of the wire.

The connecting portion may include a first extension portion that is formed by bending one side of the bus bar inwardly, and a second extension portion that is integrally formed with the first extended portion but that is extended at a predetermined angle therewith, wherein the circular bent portion may be formed in the connected portion between the first extension portion and the second extension portion, and has a curvature radius such that the outer circumference of the wire coincides with the curvature.

A crossing angle between the first extension portion and the second extension portion may be acute, and the outer circumference of the wire may be in a surface contact state with the inside surface of the bent portion between the first extension portion and the second extension portion.

The curvature radius and the section radius of the wire may be identical to each other.

The inside surface of the bent portion and the outside surface of the wire are welded to each other to be electrically connected.

The bus bar may include a U-bus bar, a V-bus bar, and a W-bus bar that supply 3-phase power, wherein the connecting portion may be respectively integrally formed with the U-bus bar, the V-bus bar, and the W-bus bar, and further the U-bus bar, the V-bus bar, and the W-bus bar may be respectively fabricated through different molds.

A vehicle according to an exemplary embodiment of the present invention may include a wheel that is disposed at a lower portion of a vehicle body, and the motor unit that is disposed in the vehicle body to transfer torque to the wheel so as to move the vehicle body.

In the motor unit according to the present invention as stated above, the connecting portion of the bus bar includes a bent portion, and one end portion of the wire wound on the bus bar contacts the bent portion such that welding becomes easier and the welded portion is firm.

Further, the connecting portion includes the first extension portion and the second extension portion that are at an acute angle such that the wire is not separated from the connecting portion and the welding process becomes easier.

### BRIEF DESCRIPTION OF THE DRAWINGS

FIG. 1 is a perspective view of a central distribution unit that is mounted in a motor unit according to an exemplary embodiment of the present invention.

FIG. 2 is an exploded perspective view of a central distribution unit that is mounted in a motor unit according to an exemplary embodiment of the present invention.

FIG. 3 is a partial perspective view of a central distribution unit that is mounted in the motor unit according to an exemplary embodiment of the present invention.

FIG. 4 is a partial top plan view of a central distribution unit that is mounted in a motor unit according to an exemplary embodiment of the present invention.

### DESCRIPTION OF SYMBOLS

100: central distribution unit
110a: U-terminal
110b: V-terminal
110c: W-terminal
200a: U-bus bar
200b: V-bus bar
200c: W-bus bar
200d: ground bus bar
300: connecting portion
300a: first extension portion
300b: bent portion
300c: second extension portion
400: wire
410: welding portion

### DETAILED DESCRIPTION OF THE EMBODIMENTS

An exemplary embodiment of the present invention will hereinafter be described in detail with reference to the accompanying drawings,

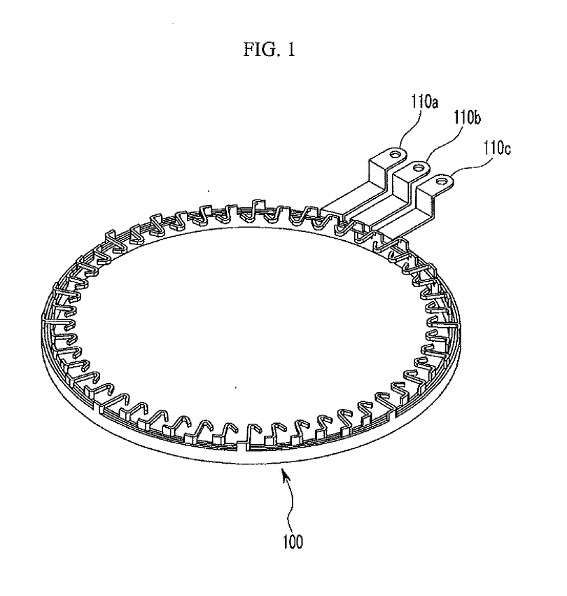

FIG. 1 is a perspective view of a central distribution unit that is mounted in a motor unit according to an exemplary embodiment of the present invention.

Referring to FIG. 1, a motor unit includes a central distribution unit 100, and the central distribution unit 100 is included in a stator of a motor unit to centralize current energy on a wound wire.

The rotor and the stator included in a motor unit are known to the public, so detailed descriptions thereof are omitted in an exemplary embodiment of the present invention.

As shown, the central distribution unit 100 has a ring shape, and a U-terminal 110a, a V-terminal 110b, and a W-terminal 110c respectively protrude outwardly so as to receive 3-phase power.

The U-terminal 110a, the V-terminal 110b, and the W-terminal 110c are connected to an external battery or a generator (not shown) to receive a 3-phase current. Further, a non-illustrated wire is wound along the central distribution unit 100, and the central distribution unit 100 supplies the current with the wire.

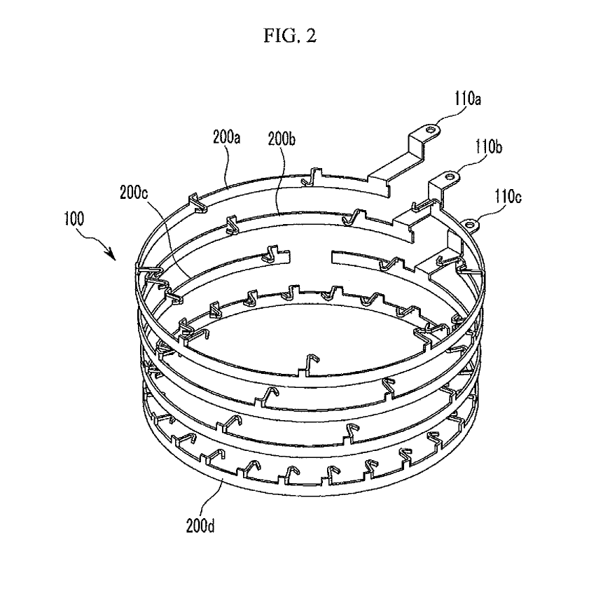

FIG. 2 is an exploded perspective view of the central distribution unit 100 that is mounted in a motor unit according to an exemplary embodiment of the present invention.

Referring to FIG. 2, the central distribution unit 100 includes a U-bus bar 200a, a V-bus bar 200b, a W-bus bar 200c, and a ground bus bar 200d that have a ring shape, and the U-terminal 110a is formed on the U-bus bar 200a, the V-terminal 110b is formed on the V-bus bar 200b, and the W-terminal 110c is formed on the W-bus bar 200c.

The U-bus bar 200a receives a current through the U-terminal 110a, the V-bus bar 200b receives a current through the V-terminal 110b, and the W-bus bar 200c receives a current through the W-terminal 110c.

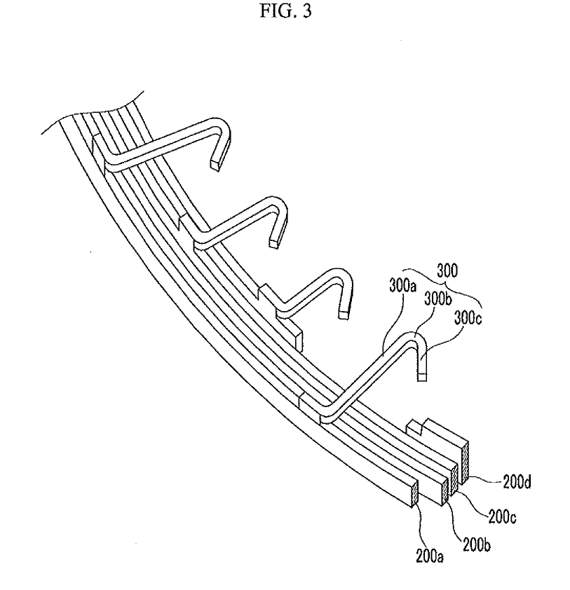

FIG. 3 is a partial perspective view of the central distribution unit that is mounted in the motor unit according to an exemplary embodiment of the present invention.

Referring to FIG. 3, a connecting portion 300 is respectively formed at the U-bus bar 200a, the V-bus bar 200b, the W-bus bar 200c, and the ground bus bar 200d, and the connecting portion 300 is respectively connected to one end portion of a wire that is wound along the central distribution unit 100.

More particularly, one end of a first wire (not shown) that is wound along the central distribution unit 100 is connected to the connecting portion 300 of the U-bus bar 200a, and the other end thereof is connected to a connecting portion of the ground bus bar 200d.

Further, one end of a second wire (not shown) that is wound along the central distribution unit 100 is connected to a connecting portion of the V-bus bar 200b, and the other end thereof is connected to a connecting portion of the ground bus bar 200d.

One end of a third wire (not shown) that is wound along the central distribution unit 100 is connected to a connecting portion of the W-bus bar 200c, and the other end thereof is connected to a connecting portion of the ground bus bar 200d.

Accordingly, the number of connecting portions that are formed along the ground bus bar 200d is the same as the sum of the connecting portions that are formed along the U-bus bar 200a, the V-bus bar 200b, and the W-bus bar 200c.

Referring to FIG. 3, the connecting portion 300 is formed by incising one side of the U-bus bar 200a to be integrally formed therewith, and the connecting portion 300 includes a first extension portion 300a, a bent portion 300b, and a second extension portion 300c.

The first extension portion 300a is extended in a central portion of the central distribution unit 100, and the second extension portion 300c is bent to be at a predetermined acute angle with the first extension portion 300a.

The inner surface of the bent portion 300b where the first extension portion 300a and the second extension portion 300c are connected corresponding to an outer circumference of the wire has a predetermined radius along one part of a circle.

Referring to FIG. 2 and FIG. 3, the U-terminal 110a, the V-terminal 110b, and the W-terminal 110c are respectively integrally formed on the U-bus bar 200a, the V-bus bar 200b, and the W-bus bar 200c, and the respective connecting portions 300 are integrally formed between them.

Accordingly, because the shapes thereof are different from each other, it is desirable that a separate mold is used to form the respective bus bars in an exemplary embodiment of the present invention.

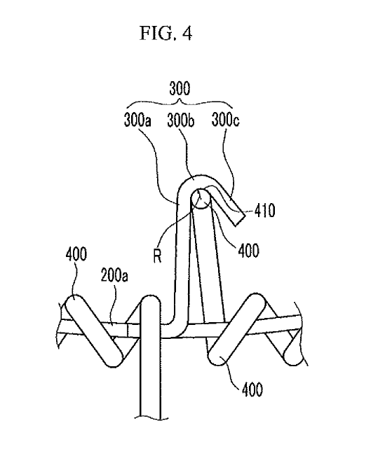

FIG. 4 is a partial top plan view of a central distribution unit that is mounted in a motor unit according to an exemplary embodiment of the present invention.

Referring to FIG. 4, a wire 400 is in surface contact with the inner surface 410 of the bent portion 300b between the first extension portion 300a and the second extension portion 300c in the connecting portion 300 that is formed on the U-bus bar (200a) and is welded thereto.

The wire 400 has a section of a predetermined radius, and the bent portion 300b is bent to have the predetermined radius along the outer circumference of the wire 400.

If the angle that the first bent portion 300b and the second bent portion 300b crosses is larger than 90 degrees, the wire 400 can be separated from the bent portion, but because the angle is, e.g., 60 degrees that is smaller than 90 degrees, the wire between the first bent portion 300b and the second bent portion 300b can be securely positioned.

Accordingly, the wire 400 can be easily welded to the bent portion 300b, and the welding portion 410 is firmly fixed thereto after the welding process.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A motor unit, comprising:
a bus bar receiving a current from a power supply;
a wire that is wound along the bus bar; and
a connecting portion that is extended from the bus bar to be electrically connected to one end portion of the wire,
wherein the connecting portion has a circular bent portion that is formed along the outer circumference of the wire.

2. The motor unit of claim 1, wherein the connecting portion comprises:
a first extension portion that is formed by bending one side of the bus bar inwardly; and
a second extension portion that is integrally formed with the first extended portion, but that is extended at a predetermined angle therewith,
wherein the circular bent portion is formed in the connected portion between the first extension portion and the second extension portion, and has a curvature radius such that the outer circumference of the wire coincides with the curvature.

3. The motor unit of claim 2, wherein a crossing angle between the first extension portion and the second extension portion is acute, and the outer circumference of the wire is in a surface contact state with the inside surface of the bent portion between the first extension portion and the second extension portion.

4. The motor unit of claim 2, wherein the curvature radius and the section radius of the wire are identical to each other.

5. The motor unit of claim 2, wherein the inside surface of the bent portion and the outside surface of the wire are welded to each other to be electrically connected.

6. The motor unit of claim 1, wherein the bus bar includes a U-bus bar, a V-bus bar, and a W-bus bar that supply 3-phase power,
wherein the connecting portion is respectively integrally formed with the U-bus bar, the V-bus bar, and the W-bus bar; and
further wherein the W-bus bar, and the U-bus bar, the V-bus bar, and the W-bus bar are respectively fabricated through different molds.

7. A vehicle, comprising:
a wheel that is disposed at a lower portion of a vehicle body; and
a motor unit according to claim 1, which is disposed in the vehicle body to transfer torque to the wheel so as to move the vehicle body.

8. A vehicle, comprising:
a wheel that is disposed at a lower portion of a vehicle body; and
a motor unit according to claim 2, which is disposed in the vehicle body to transfer torque to the wheel so as to move the vehicle body.

9. A vehicle, comprising:
a wheel that is disposed at a lower portion of a vehicle body; and
a motor unit according to claim 3, which is disposed in the vehicle body to transfer torque to the wheel so as to move the vehicle body.

10. A vehicle, comprising:
a wheel that is disposed at a lower portion of a vehicle body; and
a motor unit according to claim 4, which is disposed in the vehicle body to transfer torque to the wheel so as to move the vehicle body.

11. A vehicle, comprising:
a wheel that is disposed at a lower portion of a vehicle body; and
a motor unit according to claim 5, which is disposed in the vehicle body to transfer torque to the wheel so as to move the vehicle body.

12. A vehicle, comprising:
a wheel that is disposed at a lower portion of a vehicle body; and
a motor unit according to claim 6, which is disposed in the vehicle body to transfer torque to the wheel so as to move the vehicle body.
